(19) United States
(12) Patent Application Publication
(10) Pub. No.: US 2026/0189660 A1
(43) Pub. Date: Jul. 2, 2026

(54) MITIGATING LEAKAGE FOR TELECOMMUNICATIONS SERVICE PROVIDERS

(71) Applicant: T-Mobile USA, Inc., Bellevue, WA (US)

(72) Inventors: Henry P. Cyril, Bothell, WA (US); Jyot Kumar, Sammamish, WA (US); Bhanu Prasad, Bellevue, WA (US); Shrustishree Sumanth, Bothell, WA (US); Mullaiarasu Sundaramurthy, Maple Valley, WA (US)

(21) Appl. No.: 19/002,692

(22) Filed: Dec. 27, 2024

(51) Int. Cl. H04M 15/00

(52) U.S. Cl. CPC H04M 15/725; H04M 15/41; H04M 15/64

(57) ABSTRACT

A computer-implemented method for mitigating leakage for a telecommunications service provider includes receiving real-time call detail records (CDRs) from an online charging system (OCS) for multiple wireless devices. The CDRs comprise information regarding telecommunication sessions, with a number of CDRs per time segment corresponding to a number of sessions. The method includes associating each CDR with a cluster using a network service product type, creating aggregated sub-clusters of CDRs, and predicting, by an artificial intelligence (AI) model using the aggregated sub-clusters and number of CDRs per time segment, whether the sub-clusters are associated with leakage. Responsive to predicting a particular sub-cluster is associated with leakage, the method performs an action to mitigate the leakage. The method further includes re-predicting whether the particular sub-cluster is associated with additional leakage and performing an additional action to mitigate the additional leakage if predicted.

### BACKGROUND

Telecommunications service providers offer voice, data, and messaging services to customers through wireless networks. Such providers utilize complex billing and charging systems to track usage and apply appropriate rates for different types of services and plans. This requires processing large volumes of call detail records (CDRs) containing information about individual communication sessions. Online charging systems (OCS) of telecommunications service providers are configured to perform real-time rating and charging for prepaid and postpaid services as communication sessions occur based on the CDRs. The OCS can apply defined plans and policies to determine the appropriate charges for each session based on factors like service type, duration, and the customer's specific plan details.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates a system for network provisioning and billing in a telecommunications network according to some implementations of the disclosed technology.

FIG. 4 is a block diagram that illustrates a proactive revenue leak identification (PRLI) platform according to some implementations of the disclosed technology.

FIG. 5 is a block diagram that illustrates a system for anomaly detection and recommendation in a telecommunications network according to some implementations of the disclosed technology.

FIG. 6 is a flowchart that illustrates a process for mitigating leakage in a telecommunications system according to some implementations of the disclosed technology.

FIG. 7 is a block diagram that illustrates an example of a computer system in which at least some operations described herein can be implemented.

FIG. 8 is a block diagram that illustrates an example of an artificial intelligence (AI) systemin which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology relates to mitigating resource overuse and revenue leakage for telecommunications service providers. Specifically, the present technology addresses the challenge of such leakage in telecommunications networks, which occurs when network services are provided but not accurately billed. Conventionally leakages have been identified by processing call detail records (CDRs) and calculating the amount of revenue lost based on data usage that was provided with reduced or zero attributions (e.g., with reduced price or free of charge). As networks become more complex and offer a wider range of services and pricing plans, conventional technologies cannot account for interactions and settings associated with multiple systems (e.g., network provisioning systems, online charging systems, billing management systems, and roaming partner systems) thus resulting in insufficient detection of leakages. Further, conventional technologies cannot identify and mitigate leakages timely (e.g., in real time or near real time). For example, processing CDRs and calculating the revenue lost with conventional methods can take at least a week during which time the revenue losses continue to accrue. Such delays in mitigating leakages can further result in an expenditure of computing and networking resources by providing services to customers that they are not entitled to have, resulting in unwarranted usage of network provisioning resources. This can lead to overloading the telecommunication infrastructure resulting in technical losses and system stress, inefficiencies, and breakdowns.

The present technology provides a system that uses artificial intelligence (AI) to analyze real-time CDRs, predict potential leakage, and take immediate action to mitigate it. This approach may overcome the limitations of conventional methods, which may be slow to detect issues, require manual intervention, or lack the ability to adapt to rapidly changing network conditions and service offerings. By providing an automated and proactive leakage mitigation, the present technology can help service providers reduce revenue loss and improve billing accuracy in increasingly complex telecommunications environments. The present technology uses an AI model to analyze real-time CDRs received from an online charging system (OCS) to detect and prevent revenue losses due to incorrect billing or provisioning of network services. By aggregating and clustering CDRs based on network service product types and analyzing trends by the AI model, the system can predict potential leakage issues and take automated actions to prevent or mitigate them timely.

In one example, a computer-implemented method for mitigating leakage for a telecommunications service provider includes receiving, from an online charging system (OCS), real-time CDRs for multiple wireless devices subscribed to the telecommunications service provider. The real-time CDRs comprise information regarding telecommunication sessions of the multiple wireless devices, where a number of the real-time CDRs per a time segment correspond to a number of telecommunication sessions by the multiple wireless devices by the time segment. The information comprises a network service product type of multiple network service product types associated with each of the telecommunication sessions. In an instance that the OCS has failed to identify an applicable category for one or more of the telecommunications sessions, the real-time CDRs associated with the one or more of the telecommunications sessions comprise an indication that the one or more of the telecommunications sessions were provided with no attribution. The method includes associating each of the CDRs with a respective cluster of multiple clusters using the network service product type associated with each of the CDRs. The method includes creating aggregated sub-clusters of CDRs. Each aggregated sub-cluster of CDRs includes a portion of the CDRs associated with a respective cluster, and each aggregated sub-cluster of CDRs includes CDRs associated with the one or more of the telecommunications sessions comprising the indication that the one or more of the telecommunications sessions were provided with no attribution. The method includes inputting the aggregated sub-clusters of CDRs and a number of CDRs per the time segment to an artificial intelligent (AI) model to evaluate whether the aggregated sub-clusters of CDRs are associated with a leakage due to the one or more of the telecommunications sessions being provided with no attribution. Responsive to an evaluation that a particular aggregated sub-cluster of CDRs is associated with the leakage, the method performs an action to mitigate the leakage. Subsequent to performing the action to mitigate the leakage, the method includes applying the AI model on additional CDRs to evaluate whether the particular aggregated sub-cluster of CDRs is associated with an additional leakage. The additional CDRs are received subsequent to performing the action to mitigate the leakage, and responsive to a prediction that the particular aggregated sub-cluster of CDRs is associated with the additional leakage, the method includes performing an additional action to mitigate the additional leakage.

In another example, a system for mitigating leakage for a telecommunications service provider includes at least one hardware processor and at least one non-transitory memory storing instructions. When executed by the at least one hardware processor, the instructions cause the system to receive, from an online charging system (OCS), real-time CDRs for multiple wireless devices subscribed to the telecommunications service provider. The real-time CDRs comprise information regarding telecommunication sessions of the multiple wireless devices, where a number of the real-time CDRs per a time segment corresponds to a number of telecommunication sessions by the multiple wireless devices by the time segment, and where the real-time CDRs associated with the one or more of the telecommunications sessions comprise an indication of an attribution for each telecommunications session. The system associates each of the CDRs with a respective cluster of multiple clusters using a network service product type associated with each of the CDRs. The system creates aggregated sub-clusters of CDRs. Each aggregated sub-cluster of CDRs includes a portion of the CDRs associated with a respective cluster, and each aggregated sub-cluster of CDRs is created based on the attribution for each telecommunications session. The system inputs the aggregated sub-clusters of CDRs and the number of CDRs per the time segment to an AI model to evaluate, whether the aggregated sub-clusters of CDRs are associated with a leakage. Responsive to an evaluation that a particular aggregated sub-cluster of CDRs is associated with the leakage, the system performs an action to mitigate the leakage.

In yet another example, a non-transitory, computer-readable storage medium comprises instructions recorded thereon. When executed by at least one data processor of a system, the instructions cause the system to receive, from an online charging system (OCS), real-time call detail records (CDRs) for multiple wireless devices. The real-time CDRs comprise information regarding telecommunication sessions of the multiple wireless devices subscribed to the telecommunications service provider, where a number of the real-time CDRs per a time segment corresponds to a number of telecommunication sessions by the multiple wireless devices by the time segment, and where the real-time CDRs associated with the one or more of the telecommunications sessions comprise an indication of an attribution for each telecommunications session. The instructions cause the system to associate each of the CDRs with a respective cluster of multiple clusters using a network service product type associated with each of the CDRs. The system creates aggregated sub-clusters of CDRs. Each aggregated sub-cluster of CDRs includes a portion of the CDRs associated with a respective cluster, and each aggregated sub-cluster of CDRs is created based on the attribution for each telecommunications session. The system inputs the aggregated sub-clusters of CDRs and the number of CDRs per the time segment to an AI model to evaluate whether the aggregated sub-clusters of CDRs are associated with a leakage. Responsive to an evaluation that a particular aggregated sub-cluster of CDRs is associated with the leakage, the system performs an action to mitigate the leakage.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

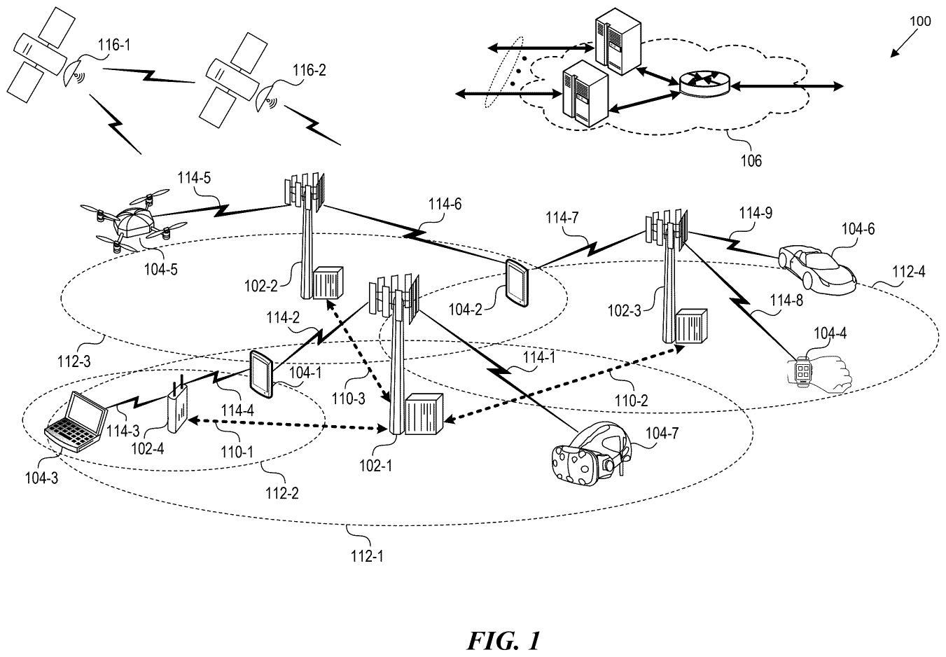

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

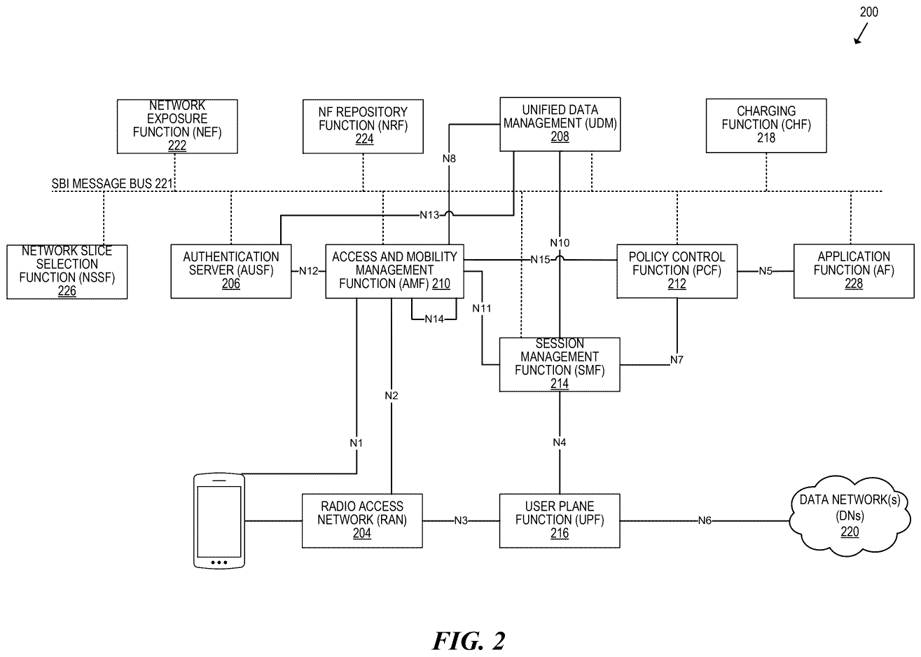

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Mitigating Leakage in Telecommunications Networks

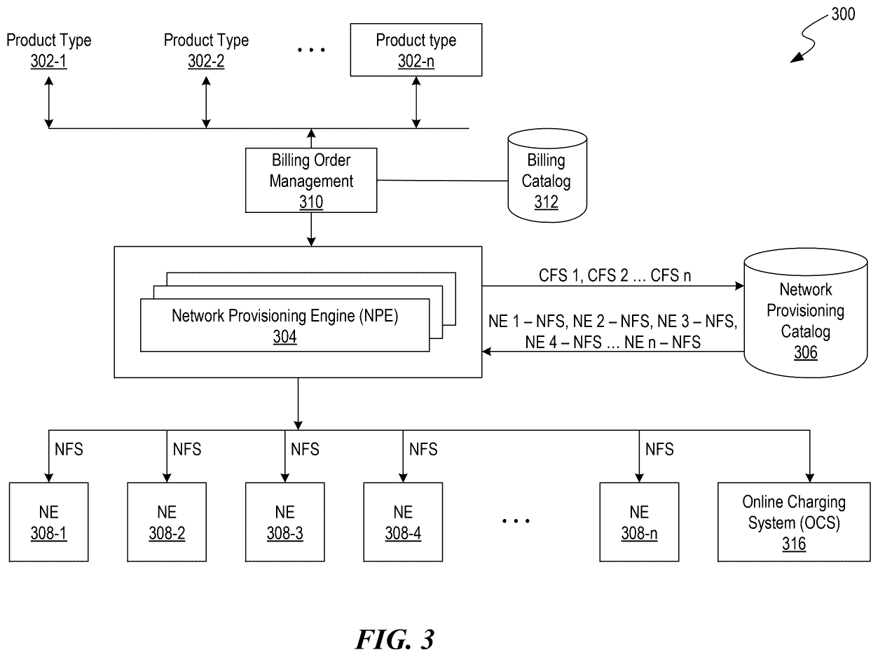

FIG. 3 is a block diagram that illustrates a system 300 for management of network services and online charging. The system 300 includes a network provisioning engine (NPE) 304, a billing order management 310, a billing catalog 312, a network provisioning catalog 306, multiple network elements (NEs) 308 (e.g., NEs 308 including NEs 308-1 through 308-n) and online charging system (OCS) 316.

The NPE 304 is configured to manage network services enabling operation of wireless devices in a network (e.g., the wireless devices 104 in the wireless network 100 in FIG. 1). The network services are provided to wireless devices via the NEs 308 such as base stations (e.g., the base stations 102 in FIG. 1). In some implementations, the NEs can include routers, switches, gateways, firewalls, and other equipment that facilitate wireless communication and data transfer. A new network service product (or a modification to an existing network service product) can be requested by the billing order management 310 (e.g., through an Application Programming Interface (API)) as an activation provision request. For example, the billing order management 310 sends a request for a new product to the NPE 304. The new product is defined by CFSs (e.g., CFS 1, CFS 2, . . . ) (also referred to as CFS features). The CFSs define a variety of functionalities and can be specific to product types (e.g., product types 302-1 through 302-n). A product type can refer to, for example, a prepaid versus postpaid network service. In some implementations, one or more product types can be associated with a partner corresponding to a third-party service provider that collaborates with the network service provider associated with the wireless network (e.g., the wireless network 100 of FIG. 1). A partner can be, for example, a roaming partner (e.g., a roaming partner located in a different country than the wireless network 100).

A first product type can require a first set of CFSs, a second product type can require a second set of CFSs, and a partnering product type can require a third set of CFSs where the first, second, and third sets of CFSs can be different from each other. Exemplary services that can be defined by CFSs include rate plans; add-on services; which access point name to use; whether the partner or product type uses the network service provider's voicemail service; whether short message service (SMS) is enabled; limitations on data usage; whether roaming is enabled; whether 5G standalone is enabled; whether real-time data metering is enabled; and whether Internet of Things (IoT) is enabled.

The sets of CFSs associated with the product types are defined by and retrieved from the billing catalog 312 by the billing order management 310. The sets of CFSs are received from the billing order management 310 by the NPE 304, which transmits the CFSs to the network provisioning catalog 306. The network provisioning catalog 306 is a repository that contains configurations, resources, and information required to provision network services to customers. The network provisioning catalog 306 translates the received sets of CFSs to sets of NFSs associated with the NEs 308. For example, a set of CFSs required for a new network product is translated by the network provisioning catalog 306 so that the network infrastructure (e.g., including the NEs 308) can be provisioned to provide the new network product to clients. The NPE 304 can receive the NFSs from the network provisioning catalog 306 and facilitate implementation of the product through the NEs 308. Anomalies in the network provisioning, for example, disparities between the CFSs and the NFSs for a product, can cause a failure of the product.

As an example, when a customer purchases a service associated with a product type (e.g., the product types 302-1 through 302-n), the transaction is processed by the NPE 304 as an activation provision request, which includes a list of CFSs. The CFSs can define, for example, services such as voice call, SMS, data, Wi-Fi calling, scam protection, and companion device pairing. The network provisioning catalog 306 translates these CFSs into NFSs. The NFSs can include thousands of network attributes that are associated with the CFSs (e.g., around 10,000 network attributes). The NPE 304 provisions various NEs (e.g., 10 to 20 NEs) through multiple APIs to enable the service.

The OCS 316 is configured to charge subscribers (customers) of the network service provider in real time based on their service usage (e.g., voice calls, video calls, SMS, data transfer, roaming, voicemail, content purchases, and/or other purchases). In some implementations, the service usage corresponds to one or more telecommunications sessions (e.g., a continuous period of communication between two or more devices over a telecommunications network in a form of communication voice calls, video calls, SMS, or data transfer). The OCS 316 can receive metering data from the core network (e.g., the AMF 210 and/or UPF 216 described with respect to FIG. 2). The metering data includes details of the telecommunications sessions, such as duration, data usage, service type, time and data, subscriber information, geographic location information, etc. OCS 316 manages the subscriber's account balance to ensure accurate and real-time charging. The NPE 304 is further configured to provision the OCS 316. The provisioning by the NPE 304 can include activating necessary services (via the NEs 308) and allocating network resources such as bandwidth and Internet Protocol (IP) addresses to subscribers. The provisioning can further include updating the OCS 316 with real-time data about user activities and resource usage, ensuring accurate and timely charging based on the user's plans.

The OCS 316 can determine rates according to the provisioning by the NE 308. A rate can be determine based on the type of product, type of network service (e.g., a voice call, SMS, or data), duration, geographic location of the device (e.g., roaming or in-network). For roaming, charging rates (e.g., price per minute, price per an SMS, or price per amount of data) are pre-determined based on the partnering operator agreements and/or by geographical locations (e.g., a call from the USA to a foreign country, a call from a foreign country to the USA, or a call from a foreign country to the same or different foreign country). In some embodiments, the OCS 316 determines the charging rates using a data flow rating tree.

An anomaly leading to a leakage can occur if a subscriber profile in OCS 316 is not correctly provisioned. For example, an anomaly can occur if offers, data usage thresholds, or offer attributes associated with a product type are either not provisioned or are incorrectly provisioned. As another example, an anomaly can occur if no rate plan is pre-determined for a roaming service. In such instances, the charging system won't be able to correctly rate or meter the calls/sessions of the subscriber. Specifically, in order to avoid customer dissatisfaction, in instances where the incorrect provisioning would cause a customer to not be able to use the service, or would be over charged for the service, the system will provide the service to the customer for free. This can cause a significant leakage.

In an exemplary instance, a subscriber has purchased an international roaming data pass for an international trip. For the international roaming data pass to work, a first offer should be provisioned to the subscriber's profile in the OCS 316. Due to a system error, a second offer has been provisioned to the subscriber's profile. The second offer does not allow data access for international roaming so the subscriber won't be able to access data. In such instances, either the subscriber cannot use the roaming service and there is a leakage due to that or the subscriber is allowed to use the roaming service without attribution (e.g., free of charge) causing a leakage.

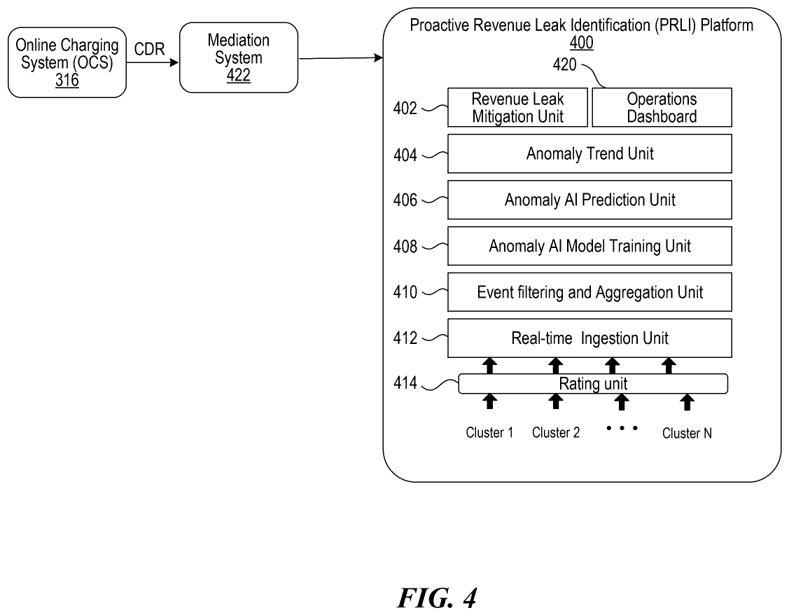

FIG. 4 is a block diagram that illustrates a proactive revenue leak identification (PRLI) platform 400. The PRLI platform 400 is in communication with the OCS 316 via a mediation system 422. The mediation system 422 is configured to receive CDRs from the OCS 316, modify the CDRs to be in a format that can be readable by the PRLI platform 400, and transmit the CDRs to the PRLI platform 400.

A CDR can include information regarding a date, time, duration, source and destination numbers, and the type of call (e.g., voice, SMS) of a telecommunication transaction. The CDR can also include a charge determined by the OCS 316 using the information of a respective CDR. Each CDR can be associated with a telecommunication session. The mediation system 422 can process the CDRs by modifying the format of the CDRs received from the OCS 316. Table 1 includes exemplary CDRs for a set of voice calls. As shown, Table 1 includes an identification number (e.g., Mobile Station International Subscriber Directory Number (MSISDN)) for an initiator and call terminator, a service type (voice), service category (e.g., ILD referring to International Long Distance), country of the call terminator, and charges determined by the OCS 316 according to a rate plan. Table 1 further includes an indication field that can include an indication or a flag provided by the OCS 316 to notify of an issue. For example, in Table 1, the indication field includes a flag (“FREE”) noting that the last voice call on the list, terminating to Brazil, was not charged (e.g., charges are not available). This flag can be an indication of an instance where the OCS 316 was not able to charge the voice call because there is no rate plan in place for voice calls from the USA to Brazil or that the provisioning of the OCS 316 or the NEs 308 in FIG. 3 is incorrect. The flag indicates that the voice call was free of charge (or optionally charged with a lower rate than expected) for the subscriber making the voice call and therefore a loss of revenue for the network service provider.

TABLE 1
Exemplary CDRs

| Call | Call | Service | Cate- | | | Indication |
|---|---|---|---|---|---|---|
| initiator | terminator | Type | gory | Country | Charges | field |
| +1 1 . . . | +86 . . . | VOICE | ILD | China | 0.25 | NULL |
| +1 2 . . . | +1 . . . | VOICE | ILD | Canada | 0.25 | NULL |
| +1 3 . . . | +81 . . . | VOICE | ILD | Japan | 0.10 | NULL |
| +1 4 . . . | +55 . . . | VOICE | ILD | Brazil | NA | FREE |

The PRLI platform 400 includes a rating unit 414, a real-time ingestion unit 412, an event filtering and aggregation unit 410, an anomaly AI model training unit 410, an anomaly AI prediction unit 406, an anomaly trend unit 404, an operations dashboard 420, and a revenue leak mitigation unit 402. PRLI platform 400 receives the CDRs from the mediation system 422 and pre-processes the CDRs before submitting them to the anomaly AI prediction unit 406. In some implementations, pre-processing includes organizing the CDRs within clusters (e.g., Cluster 1 through N) in accordance with a product type. For example, cluster 1 is associated with the product type 302-1 in FIG. 3, cluster 2 is associated with the product type 302-2 in FIG. 3, etc. In some embodiments, the clustering is performed by the mediation system 422.

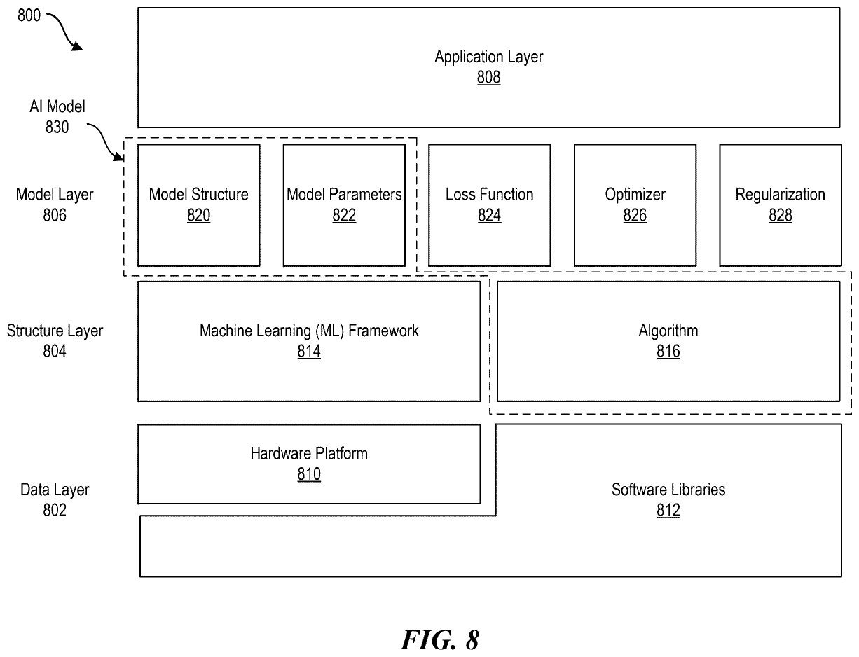

The real-time ingestion unit 412 is configured to continuously collect, process and store the clusters of CDRs. The event filtering and aggregation unit 410 is configured to reduce the amount of CDRs to be processed by the anomaly AI prediction unit 406. The filtering can include excluding from the clusters of CDRs such CDRs that do not include any indications of possible anomalies (e.g., the first three CDRs in Table 1). The event filtering and aggregation unit 410 further aggregates the clustered CDRs to sub-clusters using information of the CDRs. The sub-clustering can be performed, for example, based on service type, time and date, subscriber information, geographic location, telecommunications session duration, etc. The anomaly AI prediction unit 406 processes the aggregated sub-clusters using a trained AI model (e.g., an AI model described with respect to FIG. 8) of CDRs to predict whether the aggregated sub-clusters of CDRs are associated with a leakage. The anomaly trend unit 404 further can predict whether there is an increasing trend indicating that the leakage is likely to occur or will occur with a greater impact. The revenue leak mitigation unit 402 is configured to determine, with the anomaly AI prediction unit, mitigating actions (e.g., automated actions) to be done to prevent or mitigate the leakage. Further, the operations dashboard 420 can provide information of the leakage to users and allow users to take manual actions. The PRLI platform 400 further includes the anomaly AI model training unit configured to continuously evaluate and train the AI model using the CRDs received from the mediation system 422 and an actual outcome (e.g., whether there was a leakage or not and the cause of an occurred leakage).

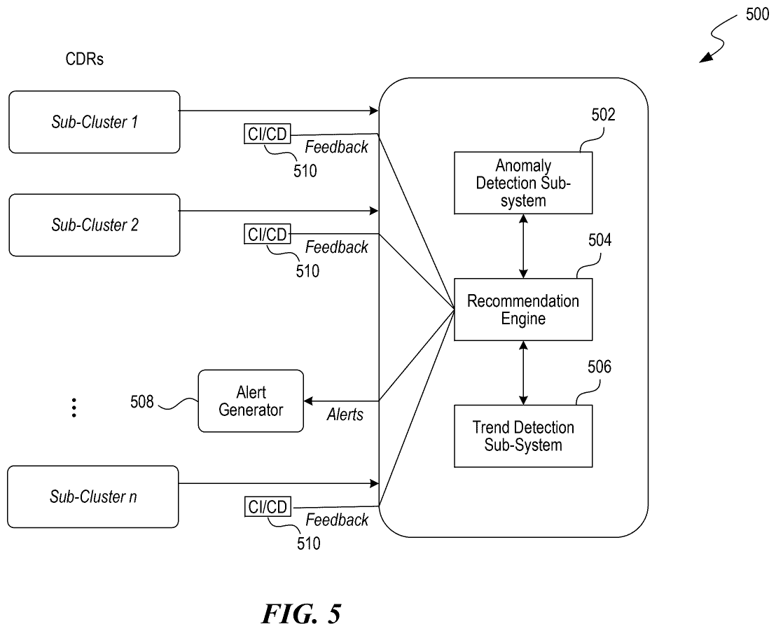

FIG. 5 is a block diagram that illustrates an AI system 500 for anomaly detection and recommendation in a telecommunications network. The operations described with respect to the anomaly AI prediction unit 406, the anomaly trend unit 404, and the revenue leak mitigation unit 402 of the platform 400 can be performed by the system 500. The principles of an AI system are described with respect to the AI system 800 of FIG. 8. The AI system 500 can include an anomaly detection sub-system 502, a recommendation engine 504 and a trend detection sub-system 506.

The AI system 500 receives the processed CDRs aggregated in sub-clusters (e.g., sub-clusters 1 through n) as described with respect to FIG. 4. The anomaly detection sub-system 502 evaluates, using an AI model, whether each of the aggregated sub-clusters of CDRs are associated with a leakage and, if yes, what type of cause is leading to the leakage. The evaluation can include inputting the aggregated sub-clusters of CDRs and a number of CDRs per a time segment to the AI model. The number of CDRs corresponds to the total number of telecommunications sessions that were established during the time segment. The AI model, which can be trained using historical CDR data and historical outcomes (e.g., leakage occurrences and types of leakages), evaluates, based on the current aggregated sub-clusters of CDRs and the number of CDRs, whether there is a current leakage and what is the type of the leakage. The AI model can be continuously trained by collected and processed CDRs, and the detected leakages associated with respective CDRs.

Further, the trend detection sub-system 506 can predict whether an identified anomaly could lead to a leakage and can evaluate an impact of the leakage (e.g., whether the leakage is significant or minimal). For example, the AI model can be trained to identify using the input data whether there is a likelihood (e.g., a likelihood that is above a threshold likelihood) that a leakage can occur. The AI model can further be trained to predict an impact of leakages using historical CDR data and historical leakage impacts. The impact can be, for example, a percentage of revenue loss.

Further, the recommendation engine 504 can create suggestions of mitigating actions to be done to prevent the leakage or mitigate the effects of the leakage. In some implementations, the mitigating actions can be identified from a set of mitigating actions that have been performed previously with positive outcomes. The suggestions can include a combination of mitigating actions to be performed sequentially or simultaneously.

In some implementations, the action includes generating an alert. For example, the recommendation engine 504 provides an indication of an alert to an alert generator 508. The alert generator 508 is configured to generate an alert describing the identified revenue leak and provide the generated alert to a relevant system (e.g., to the OCS 316 or the NPE 304). In some implementations, the mitigating action includes providing feedback to a continuous integration and continuous deployment (CI/CD) system 510. A CI/CD system can be configured to deploy and release network services to production, and consequently removing network services from the production. A CI/CD system can also integrate modifications to in-production network services. The CI/CD system 510 can, for example, remove the service associated with the sub-cluster of CDRs that has been identified as a leakage from the network services or to modify the relevant service.

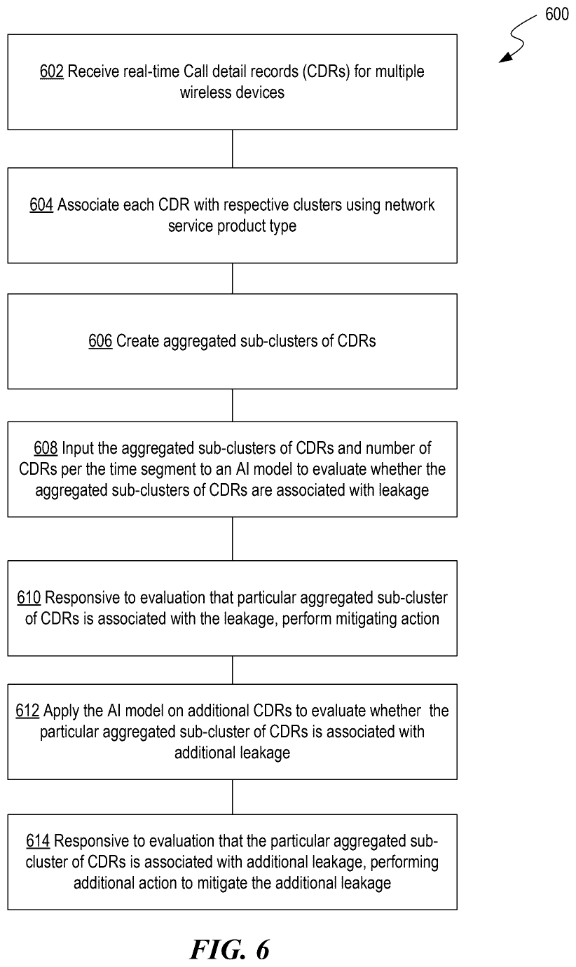

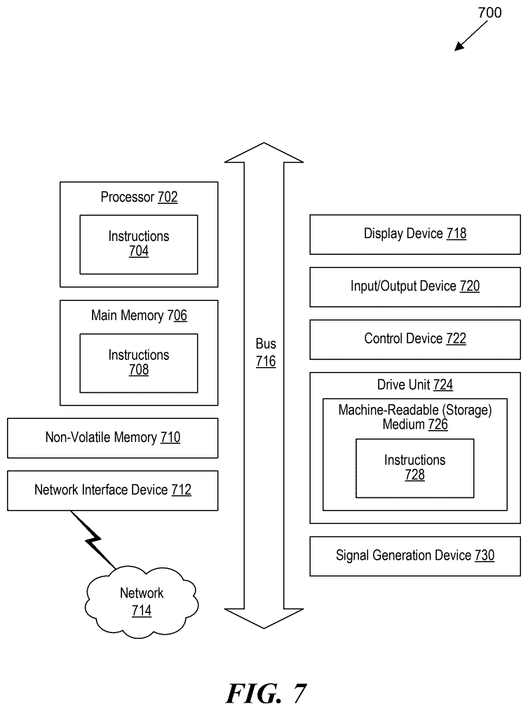

FIG. 6 is a flow diagram that illustrates a process 600 for mitigating leakage for telecommunication service providers. The process 600 can be performed by a system (e.g., the AI system 500 in FIG. 5 in communication with the system 300 in FIG. 3 for management of network services and online charging). The process can be employed in a platform such as the platform 400 in FIG. 4. The system is associated with a wireless network (e.g., the wireless network 100 in FIG. 1). The system can include at least one hardware processor and at least one non-transitory memory storing instructions (e.g., a computer system 700 described with respect to FIG. 7). When the instructions are executed by the at least one hardware processor, the system can perform the process 600.

The process 600 is directed to mitigating resource overuse and revenue leakage for telecommunication service providers using an AI model. The process can predict and resolve leaks by swiftly detecting degradations and implementing rule-based resolutions. Key benefits include proactive monitoring, real-time anomaly detection, improved system reliability, reduced customer complaints, and enhanced customer satisfaction. The AI/ML model monitors call data records to distinguish between acceptable and unacceptable free ratings, identifying issues caused by provisioning or charging errors.

At 602, the system receives, from an OCS (e.g., the OCS 316 in FIGS. 3 and 4), real-time CDRs for multiple wireless devices (e.g., the device 202 in FIG. 2) subscribed to the telecommunications service provider. The real-time CDRs can include information regarding telecommunication sessions of the multiple wireless devices (see, Table 1 above). A number of the real-time CDRs per a time segment (e.g., a minute, an hour, or two hours) can correspond to a number of telecommunication sessions by the multiple wireless devices by the time segment. The information can include a network service product type of multiple network service product types (e.g., the product types 302-1 through 302-n) associated with each of the telecommunication sessions. Examples of different product types include pre-paid and post-paid plans, rate plans (subscription plans) including one or more add-on services (e.g., voicemail), data, SMS, or voice call limited and unlimited plans, and roaming data inclusive and exclusive plans.

In an instance that the charging system has failed to identify an applicable category for one or more of the telecommunications sessions, the real-time CDRs associated with the one or more of the telecommunications sessions can include an indication that the one or more of the telecommunications sessions were provided with no attribution. For example, as described with respect to Table 1 above, the CDRs can include an indication or a flag provided by the OCS 316 to notify that a network service was provided with no attributions (e.g., free of charge or optionally charged with a lower rate than expected). In Table 1, a voice call on the list terminating to Brazil initiated by a wireless device in the USA was not charged. This can be, for example, due to the OCS 316 not being able to charge the voice call because there is no existing rate plan in place for voice calls from the USA to Brazil or that the provisioning of the OCS 316 or the NEs 308 in FIG. 3 is incorrect. Such instances can lead to a loss of revenue for the network service provider.

At 604, the system associates each of the CDRs with a respective cluster of multiple clusters (e.g., the clusters 1 through N in FIGS. 4 and 5) using the network service product type associated with each of the CDRs. This association enables the prediction of leakage by collecting the related individual CDRs to a cluster of multiple CDRs, e.g., because multiple CDRs are more likely to have a more significant impact on the revenue than a single incident.

At 606, the system creates aggregated sub-clusters of CDRs. Each aggregated sub-cluster of CDRs can include a portion of the CDRs associated with a respective cluster. Each aggregated sub-cluster of CDRs includes CDRs associated with the one or more of the telecommunications sessions comprising the indication that the one or more of the telecommunications sessions were provided with no attribution. The aggregation to sub-clusters can include removing (filtering out) CDRs that are irrelevant for leakage. Such non-relevant CDRs can include CDRs related to telecommunications sessions that have been charged with required attributions or are free of charge based on the terms of the associated network product. The sub-aggregation can further include grouping the CDRs in accordance with a set of parameters or combinations of parameters that relate to the information included in the CDRs. Examples of such parameters can include service types (e.g., voice call, SMS, data), call destination/initiation locations, and roaming partners or roaming geographical locations. The aggregation and/or filtering can increase the efficiency of the operation of the system 500 in that it reduces the amount of CDRs to be processed by an AI model and/or pre-processes the CDRs in sub-aggregates that require less time to process by the AI model. As an example, the system can collect billions of CDRs on average per day including CDRs for all product types. The filtering can reduce the CDRs significantly, e.g., to 0.1% of the average daily CDRs.

At 608, the system inputs the aggregated sub-clusters of CDRs and number of CDRs per the time segment to an AI model (e.g., the anomaly detection sub-system 502 in FIG. 5) to evaluate whether the aggregated sub-clusters of CDRs are associated with a leakage due to the one or more of the telecommunications sessions being provided with no attribution. In some implementations, evaluating whether the aggregated sub-clusters of CDRs are associated with the leakage includes identifying a trend (e.g., by the trend detection sub-system 506 in FIG. 5), using the aggregated sub-clusters of CDRs and the number of CDRs per the time segment. The trend can indicate that the particular aggregated sub-cluster will be (with a certain likelihood) associated with the leakage within a particular future time segment. In an instance that the trend indicates that the likelihood that the particular aggregated sub-cluster will be associated with a leakage is above a leakage likelihood threshold, the system can determine to treat the particular aggregated sub-cluster to be associated with a leakage.

In some implementations, predicting whether the aggregated sub-clusters of CDRs are associated with a leakage includes evaluating the aggregated sub-clusters of CDRs against the number of CDRs per the time segment. The AI model can be trained to identify whether a possible leakage has a sufficiently significant impact on revenue in order for it to be associated with a leakage. For example, a certain aggregated sub-cluster can be predicted to be associated with a certain leakage (in the present or future) but the impact of the certain leakage is below a threshold impact because the number of CDRs per the time segment is high, the AI model can forgo the association of the certain aggregated sub-cluster with a leakage. For example, in an instance that voice calls to a certain operator in Brazil are provided free of charge due to an error by the OCS, but the number of voice calls to this certain operator is low compared to all voice calls to Brazil, the AI model can forgo the association of the certain aggregated sub-cluster with a leakage. As another example, in an instance that voice calls to the certain operator in Brazil are provided with a minimal loss of revenue (e.g., charging 1% less than a correct charge would be) due to an error by the OCS, but the number of voice calls to this certain operator is high, the AI model can associate the certain aggregated sub-cluster with a leakage.

At 610, responsive to an evaluation that a particular aggregated sub-cluster of CDRs is associated with the leakage, the system performs an action to mitigate the leakage. In some implementations, the action to mitigate the leakage includes generating an alert (e.g., by the alert generator 508 in FIG. 5) that indicates that the particular aggregated sub-cluster is associated with the leakage and transmitting the alert to the OCS. In some implementations, the action to mitigate the leakage includes causing a continuous integration and continuous deployment (CI/CD) system (e.g., the CI/CD 510) to remove the particular aggregated sub-cluster from data flow. The removal can be temporary or permanent. The CI/CD system can have built-in rollback flows so that the CI/CD system is configured to undo (rollback) any cost configuration deployed in production (e.g., to cancel or withdraw the most recent cost deployment).

In some implementations, the action to mitigate the leakage can be performed within a period of time (e.g., one hour, two hours, twelve hours, twenty-four hours, etc.) of receiving the real-time CDRs. This period of time corresponds to the time required for the CDRs to be processed (e.g., as described in operations 604 through 608). The required time can depend on the total number of CDRs for the time segment, a number of aggregated sub-clusters, as well as the general processing capacity of the system. The process 600 can thus provide a significantly more efficient manner for identifying and mitigating leakage compared to conventional processes that can take at least a week during which time the revenue losses continue to accrue.

At 612, subsequent to performing the action to mitigate the leakage, the system applies the AI model on additional CDRs to evaluate whether the particular aggregated sub-cluster of CDRs is associated with additional leakage. The additional CDRs can be (as described at 602) subsequent to performing the action to mitigate the leakage. The additional CDRs are processed as described in operations 604 and 608 and can further be mapped against the particular aggregated sub-cluster of CDRs so evaluate whether the leakage has been resolved. The mapping can be performed, for example, using certain parameters of CDRs. For example, if a leakage was detected in telecommunication sessions corresponding to long-distance calls to a particular foreign country, the additional CDRs can be mapped against the detected leakage using this information (e.g., voice call type and country) in the additional CDRs. The additional leakage can be different from the leakage (e.g., caused by a different error) or the same leakage that was not resolved by the mitigating action. At 614, responsive to an evaluation that the particular aggregated sub-cluster of CDRs is associated with the additional leakage, the system performs an additional action to mitigate the additional leakage.

In some implementations, the leakage is caused by a lack of a plan for network services associated with the particular aggregated sub-cluster. The action to mitigate the leakage includes the OCS adding a plan for the network services associated with the particular aggregated sub-cluster. In some implementations, the leakage is caused by an incorrect provisioning of the OCS. The action to mitigate the leakage includes causing a network engineering engine (NPE) to correct the incorrect provisioning of the OCS.

For example, the particular sub-cluster of CDRs is associated with voice calls initiated by one or more wireless devices in a particular foreign country. The leakage can be caused by a lack of a plan for the voice calls initiated in the particular foreign country. The action to mitigate the leakage can include implementing the plan for the voice calls in the particular foreign country. As another example, the particular sub-cluster of CDRs is associated with voice calls initiated by a user of a particular wireless device in a foreign country. The leakage can be caused by incorrect charging by the OCS related to a subscription associated with the user. The action to mitigate the leakage can include causing the OCS to correct the incorrect charging related to the subscription.

In some implementations, the system receives, from a network provisioning catalog in communication with an NPE (e.g., the NPE 304 in FIG. 3), provisioning data (e.g., stored in the network provisioning catalog 306) associated with the particular aggregated sub-cluster of CDRs describing provisioning of network resources (e.g., one or more of the NEs 308-1 through 308-n in FIG. 3) or the OCS. The system identifies, by the AI model using the aggregated sub-clusters of CDRs and the provisioning data, that the leakage associated with the particular aggregated sub-cluster of CDRs is caused by an incorrect provisioning of the network resources or the OCS.

In some implementations, the system forgoes performing the mitigating action for any aggregated sub-clusters that are not associated with the leakage. For example, no action is taken with respect to sub-clusters that are not associated with the leakage or, optionally, are associated with a leakage having a too insignificant impact on the revenue that the cost of performing the action would be higher than the revenue gained.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### AI System

FIG. 8 is a block diagram that illustrates an example of an AI system 800 in which at least some operations described herein can be implemented. As shown, the AI system 800 can include a set of layers, which conceptually organize elements within an example network topology for the AI system's architecture to implement a particular AI model 830. Generally, an AI model 830 is a computer-executable program implemented by the AI system 800 that analyzes data to make predictions. Information can pass through each layer of the AI system 800 to generate outputs for the AI model 830. The layers can include a data layer 802, a structure layer 804, a model layer 806, and an application layer 808. The algorithm 816 of the structure layer 804 and the model structure 820 and model parameters 822 of the model layer 806 together form the example AI model 830. The optimizer 826, loss function engine 824, and regularization engine 828 work to refine and optimize the AI model 830, and the data layer 802 provides resources and support for the application of the AI model 830 by the application layer 808.

The data layer 802 acts as the foundation of the AI system 800 by preparing data for the AI model 830. As shown, the data layer 802 can include two sub-layers: a hardware platform 810 and one or more software libraries 812. The hardware platform 810 can be designed to perform operations for the AI model 830 and include computing resources for storage, memory, logic, and networking, such as the resources described in relation to FIG. 5. The hardware platform 810 can process amounts of data using one or more servers. The servers can perform backend operations such as matrix calculations, parallel calculations, machine learning (ML) training, and the like. Examples of servers used by the hardware platform 810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 810 can include Infrastructure as a Service (IaaS) resources, which are computing resources (e.g., servers, memory, etc.), offered by a cloud services provider. The hardware platform 810 can also include computer memory for storing data about the AI model 830, application of the AI model 830, and training data for the AI model 830. The computer memory can be a form of random-access memory (RAM), such as dynamic RAM, static RAM, and non-volatile RAM.

The software libraries 812 can be thought of as suites of data and programming code, including executables, used to control the computing resources of the hardware platform 810. The programming code can include low-level primitives (e.g., fundamental language elements) that form the foundation of one or more low-level programming languages, such that servers of the hardware platform 810 can use the low-level primitives to carry out specific operations. The low-level programming languages do not require much, if any, abstraction from a computing resource's instruction set architecture, allowing them to run quickly with a small memory footprint.

The structure layer 804 can include an ML framework 814 and an algorithm 816. The ML framework 814 can be thought of as an interface, library, or tool that allows users to build and deploy the AI model 830. The ML framework 814 can include an open-source library, an Application Programming Interface (API), a gradient-boosting library, an ensemble method, and/or a deep learning toolkit that work with the layers of the AI system to facilitate the development of the AI model 830. For example, the ML framework 814 can distribute processes for the application or training of the AI model 830 across multiple resources in the hardware platform 810. The ML framework 814 can also include a set of pre-built components that have the functionality to implement and train the AI model 830 and allow users to use pre-built functions and classes to construct and train the AI model 830. Thus, the ML framework 814 can be used to facilitate data engineering, development, hyperparameter tuning, testing, and training for the AI model 830.

The algorithm 816 can be an organized set of computer-executable operations used to generate output data from a set of input data and can be described using pseudocode. The algorithm 816 can include complex code that allows the computing resources to learn from new input data and create new/modified outputs based on what was learned. In some implementations, the algorithm 816 can build the AI model 830 through being trained while running computing resources of the hardware platform 810. This training allows the algorithm 816 to make predictions or decisions without being explicitly programmed to do so. Once trained, the algorithm 816 can run at the computing resources as part of the AI model 830 to make predictions or decisions, improve computing resource performance, or perform tasks. The algorithm 816 can be trained using supervised learning, unsupervised learning, semi-supervised learning, and/or reinforcement learning.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A computer-implemented method for a mitigation of leakage for a telecommunications service provider, the method comprising:
receiving, from an online charging system (OCS), real-time call detail records (CDRs) for multiple wireless devices subscribed to the telecommunications service provider,
wherein the real-time CDRs comprise information regarding telecommunication sessions of the multiple wireless devices,
wherein a number of the real-time CDRs per a time segment correspond to a number of telecommunication sessions by the multiple wireless devices by the time segment;
wherein the information comprises a network service product type of multiple network service product types associated with each of the telecommunication sessions, and
wherein, in an instance that the charging system has failed to identify an applicable category for one or more of the telecommunications sessions, the real-time CDRs associated with the one or more of the telecommunications sessions comprise an indication that the one or more of the telecommunications sessions were provided with no attribution;
associating each of the CDRs with a respective cluster of multiple clusters using the network service product type associated with each of the CDRs;
creating aggregated sub-clusters of CDRs,
wherein each aggregated sub-cluster of CDRs includes a portion of the CDRs associated with a respective cluster, and
wherein each aggregated sub-cluster of CDRs includes CDRs associated with the one or more of the telecommunications sessions comprising the indication that the one or more of the telecommunications sessions were provided with no attribution;
inputting the aggregated sub-clusters of CDRs and a number of CDRs per the time segment to an artificial intelligent (AI) model to evaluate whether the aggregated sub-clusters of CDRs are associated with a leakage due to the one or more of the telecommunications sessions being provided with no attribution;
responsive to an evaluation that a particular aggregated sub-cluster of CDRs is associated with the leakage, performing an action to mitigate the leakage;
subsequent to performing the action to mitigate the leakage applying the AI model on additional CDRs to evaluate whether the particular aggregated sub-cluster of CDRs is associated with an additional leakage,
wherein the additional CDRs are received subsequent to performing the action to mitigate the leakage, and
responsive to an evaluation that the particular aggregated sub-cluster of CDRs is associated with the additional leakage, performing an additional action to mitigate the additional leakage.

2. The computer-implemented method of claim 1,
wherein the action to mitigate the leakage comprises generating an alert that indicates that the particular aggregated sub-cluster is associated with the leakage and transmitting the alert to the OCS.

3. The computer-implemented method of claim 1,
wherein the action to mitigate the leakage comprises causing a continuous integration and continuous deployment (CI/CD) system to remove the particular aggregated sub-cluster from data flow.

4. The computer-implemented method of claim 1, further comprising:
receiving, from a network provisioning catalog in communication with a network provisioning engine (NPE), provisioning data associated with the particular aggregated sub-cluster of CDRs describing provisioning of network resources or the OCS;
identifying, by the AI model using the aggregated sub-clusters of CDRs and the provisioning data, that the leakage associated with the particular aggregated sub-cluster of CDRs is caused by an incorrect provisioning of the network resources or the OCS.

5. The computer-implemented method of claim 1,
wherein the leakage is caused by a lack of plan for network services associated with the particular aggregated sub-cluster, and
wherein the action to mitigate the leakage comprises the OCS adding a plan for the network services associated with the particular aggregated sub-cluster.

6. The computer-implemented method of claim 1,
wherein the leakage is caused by an incorrect provisioning of the OCS, and wherein the action to mitigate the leakage comprises causing a network engineering engine (NPE) to correct the incorrect provisioning of the OCS.

7. The computer-implemented method of claim 1, further comprising:
forgoing performing the mitigating action for any aggregated sub-clusters that are not associated with the leakage.

8. The computer-implemented method of claim 1,
wherein the action to mitigate the leakage can be performed within an hour of receiving the real-time CDRs.

9. The computer-implemented method of claim 1,
wherein evaluating whether the aggregated sub-clusters of CDRs are associated with the leakage comprises identifying a trend, using the aggregated sub-clusters of CDRs and the number of CDRs per the time segment, that the particular aggregated sub-cluster will be associated with the leakage within a particular future time segment.

10. The computer-implemented method of claim 1,
wherein the particular sub-cluster of CDRs is associated with voice calls initiated by one or more wireless devices in a particular foreign country;
wherein the leakage is caused by a lack of plan for the voice calls initiated in the particular foreign country, and
wherein the action to mitigate the leakage comprises implementing the plan for the voice calls in the particular foreign country.

11. The computer-implemented method of claim 1,
wherein the particular sub-cluster of CDRs is associated with voice calls initiated by a user of a particular wireless device in a foreign country;
wherein the leakage is caused by an incorrect charging by the OCS related to a subscription associated with the user, and
wherein the action to mitigate the leakage comprises causing the OCS to correct the incorrect charging related to the subscription.

12. A system for mitigating leakage for a telecommunications service provider, the system comprising:
at least one hardware processor; and
at least one non-transitory memory storing instructions, which, when executed by the at least one hardware processor, cause the system to:
receive, from an online charging system (OCS), real-time call detail records (CDRs) for multiple wireless devices subscribed to the telecommunications service provider,
wherein the real-time CDRs comprise information regarding telecommunication sessions of the multiple wireless devices,
wherein a number of the real-time CDRs per a time segment correspond to a number of telecommunication sessions by the multiple wireless devices by the time segment, and
wherein the real-time CDRs associated with the one or more of the telecommunications sessions comprise an indication of an attribution for each telecommunications session;
associate each of the CDRs with a respective cluster of multiple clusters using a network service product type associated with each of the CDRs;
create aggregated sub-clusters of CDRs,
wherein each aggregated sub-cluster of CDRs includes a portion of the CDRs associated with a respective cluster, and
wherein each aggregated sub-cluster of CDRs is created based on the attribution for each telecommunications session;
input the aggregated sub-clusters of CDRs and the number of CDRs per the time segment to an artificial intelligent (AI) model to evaluate whether the aggregated sub-clusters of CDRs are associated with a leakage;
responsive to an evaluation that a particular aggregated sub-cluster of CDRs is associated with the leakage, perform an action to mitigate the leakage.

13. The system of claim 12,
wherein the action to mitigate the leakage comprises generating an alert that indicates that the particular aggregated sub-cluster is associated with the leakage and transmitting the alert to the OCS.

14. The system of claim 12,
wherein the action to mitigate the leakage comprises causing a continuous integration and continuous deployment (CI/CD) system to remove the particular aggregated sub-cluster from data flow.

15. The system of claim 12, further caused to:
receive, from a network provisioning catalog in communication with a network provisioning engine (NPE), provisioning data associated with the particular aggregated sub-cluster of CDRs describing provisioning of network resources or the OCS;
identify, by the AI model using the aggregated sub-clusters of CDRs and the provisioning data, that the leakage associated with particular aggregated sub-cluster of CDRs is caused by an incorrect provisioning of the network resources or the OCS.

16. The computer-implemented method of claim 1,
wherein the leakage is caused by a lack of plan for network services associated with the particular aggregated sub-cluster, and
wherein the action to mitigate the leakage comprises the OCS adding a plan for the network services associated with the particular aggregated sub-cluster.

17. A non-transitory, computer-readable storage medium comprising instructions recorded thereon, wherein the instructions, when executed by at least one data processor of a system, cause the system to:
receive, from an online charging system (OCS), real-time call detail records (CDRs) for multiple wireless devices,
wherein the real-time CDRs comprise information regarding telecommunication sessions of the multiple wireless devices subscribed to a telecommunications service provider,
wherein a number of the real-time CDRs per a time segment correspond to a number of telecommunication sessions by the multiple wireless devices by the time segment, and
wherein the real-time CDRs associated with the one or more of the telecommunications sessions comprise an indication of an attribution for each telecommunications session;
associate each of the CDRs with a respective cluster of multiple clusters using a network service product type associated with each of the CDRs;
create aggregated sub-clusters of CDRs,
wherein each aggregated sub-cluster of CDRs includes a portion of the CDRs associated with a respective cluster, and
wherein each aggregated sub-cluster of CDRs is created based on the attribution for each telecommunications session;
input the aggregated sub-clusters of CDRs and the number of CDRs per the time segment to an artificial intelligent (AI) model to evaluate whether the aggregated sub-clusters of CDRs are associated with a leakage;
responsive to an evaluation that a particular aggregated sub-cluster of CDRs is associated with the leakage, perform an action to mitigate the leakage.

18. The non-transitory, computer-readable storage medium of claim 17,
wherein the action to mitigate the leakage comprises generating an alert that indicates that the particular aggregated sub-cluster is associated with the leakage and transmitting the alert to the OCS.

19. The non-transitory, computer-readable storage medium of claim 17,
wherein the action to mitigate the leakage comprises causing a continuous integration and continuous deployment (CI/CD) system to remove the particular aggregated sub-cluster from data flow.

20. The non-transitory, computer-readable storage medium of claim 17, wherein the system is further caused to:
receive, from a network provisioning catalog in communication with a network provisioning engine (NPE), provisioning data associated with the particular aggregated sub-cluster of CDRs describing provisioning of network resources or the OCS;
identify, by the AI model using the aggregated sub-clusters of CDRs and the provisioning data, that the leakage associated with particular aggregated sub-cluster of CDRs is caused by an incorrect provisioning of the network resources or the OCS.
